(19) United States
(12) Patent Application Publication
(10) Pub. No.: US 2012/0215048 A1
(43) Pub. Date: Aug. 23, 2012

(54) Metals solubility reduction optimization method

(76) Inventor: Keith Edward Forrester, Meredith, NH (US)

(21) Appl. No.: 13/385,334

(22) Filed: Feb. 13, 2012

Related U.S. Application Data
(60) Provisional application No. 61/463,307, filed on Feb. 15, 2011.

(51) Int. Cl. A62D 3/33

(52) U.S. Cl. 588/315

(57) ABSTRACT

This invention provides a method for heavy metal solubility reduction in waste and material by maximization of water hydration, minimization of surface area and mass, maximization of atmospheric carbonation, optimization of pH environment and optimization of stabilizing agents, such that leaching of heavy metals is inhibited to desired levels. The resultant waste or material after sequenced optimized solubility reduction would be suitable for disposal as RCRA non-hazardous waste or reuse in the environment.

### BACKGROUND OF THE INVENTION

Over the past thirty years, the potential and observed dangers of heavy metal bearing materials and waste exposure to humans and the environment has been the basis of extensive regulatory control. The leaching and transport of heavy metals into surface water bodies and groundwater is a grave concern because of the danger that the drinking water supplies and the environment will become contaminated. Heavy metal bearing materials and wastes, such as soils contaminated with industrial or commercial products or waste, paint residues, sludge, plating wastes, sediments, foundry dusts, casting sands, steel mill dusts, shredder residues, wire insulation, refuse incinerator flyash, incinerator bottom ash, scrubber residues from air pollution control devices such as cyclones, electrostatic precipitators and bag-house filter bags, may be deemed hazardous by the United States Environmental Protection Agency (U.S. EPA) pursuant to 40 C.F.R. Part 261 if containing certain soluble heavy metals above regulatory limits. Any solid waste can be defined as hazardous either because it is “listed” in 40 C.F.R., Part 261 Subpart D or because it exhibits one or more of the characteristics of a hazardous waste as defined at Part 261, Subpart C. These characteristics are: (1) ignitability, (2) corrosivity, (3) reactivity, and (4) toxicity as tested under the Toxicity Characteristic Leaching Procedure (TCLP). Heavy metal bearing materials and wastes can also be regulated under state and federal groundwater and surface water protection standards, which set total and leachable limits for heavy metals often lower than the TCLP criteria, as the wastes and materials are not in a lined landfill and exposed to direct groundwater, drinking water, storm waters and surface water bodies.

40 C.F.R., Part 261.24(a), contains a list of contaminants and their associated maximum allowable concentrations. The inorganic list includes As, Ag, Ba, Cd, Cr, Pb, Hg, and Se. If a contaminant, such as lead, exceeds its maximum allowable concentration, when tested using TCLP analysis as specified at 40 C.F.R. Part 261 Appendix 2, then the material is classified as hazardous. The TCLP test uses a dilute acetic acid either in deionized water (TCLP fluid 2) or in deionized water with a sodium hydroxide buffer (TCLP fluid 1). Both extracts attempt to simulate the leachate character from a decomposing trash landfill in which the hazardous waste being tested for is assumed to be disposed of in, and thus subject to the acetic acid leaching condition. Waste containing leachable heavy metals is currently classified as hazardous waste due to the toxicity characteristic, if the level of TCLP analysis is above 0.2 to 100 milligrams per liter (mg/L) or parts per millions (ppm) for defined metals. The TCLP test is designed to simulate a worst-case leaching situation, that is leaching conditions which would typically be found in the interior of an actively degrading municipal landfill. Such landfills normally are slightly acidic with a pH of approximately 5+0.5. Countries outside of the US also use the TCLP test as a measure of leachability such as Taiwan, Thailand, and Canada. Thailand also limits solubility of Cu and Zn, as these are metals of concern to Thailand groundwater. Switzerland and most European countries also regulate management of solid wastes by measuring heavy metals and salts as tested by a sequential leaching method using carbonated water simulating rainwater. Japan and the United Kingdom use similar DI water leach tests to measure for heavy metals.

Additionally, U.S. EPA land disposal restrictions prohibit the land disposal of treated hazardous wastes which leach in excess of maximum allowable concentrations upon performance of the TCLP analysis. The land disposal regulations require that hazardous wastes are treated until the heavy metals do not leach at UTS levels from the solid waste at levels above the maximum allowable concentrations prior to placement in a surface impoundment, waste pile, landfill or other land disposal unit as defined in 40 C.F.R. 260.10.

Leach test conditions thus include the conditions to which a sludge, ash, waste, material or soil is subjected during dilute acetic acid leaching (TCLP), buffered citric acid leaching (STLC), distilled water, synthetic rainwater (SPLP, MEP) or carbonated water leaching (Japanese, UK, Swiss, and USEPA SW-924). Synthetic rainwater leach tests are also often used to measure heavy metal solubility and compare such to groundwater and surface water state and federal standards where materials and wastes are either reused on-site or disposed in a manner other than lined landfills.

Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered acetic acid for 18 hours. The extract solution is made up from 5.7 ml of glacial acetic acid and 64.3 ml of 1.0 normal sodium hydroxide up to 1000 ml dilution with reagent water.

Suitable synthetic acid leach tests include the USEPA SW-846 Manual described Synthetic Precipitant Leaching Procedure (SPLP) and Multiple Extraction Procedure Test (MEP) now used in the US for sites where wastes are reused outside of leachate collected and lined landfills. Briefly, in a SPLP test, 100 grams of waste are tumbled with 2000 ml of dilute nitric and sulfuric acid for 18 hours. The extract solution is made up to pH at near 4.8 simulating acid rainwater East and West of the Mississippi. The MEP is the Multiple Extraction Procedure which uses the TCLP type test for the first extract and followed by 9 cycles of the SPLP, all of which report leachate values, and thus attempt to measure diffusion potential of the waste matrix.

Suitable carbonated water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO2 saturated method is the Swiss protocol using 100 grams of cemented waste at 1 cm3 in two (2) sequential water baths of 2000 ml. The concentration of heavy metals and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The heavy metal concentration is then analyzed by Inductively-Coupled Plasma (ICP) after filtration of a 100 ml aliquot from the tumbler through a 45 micron glass bead filter.

Of specific interest and concern regarding the present invention is the leaching of individual and combined heavy metal groups such as As, Ag, Ba, Cd, Cr, Cu, Pb, Se, Sb, Ni, and Zn and combinations thereof under TCLP, SPLP, MEP, CALWET, DI, rainwater and surface water conditions as well as non-landfill conditions such as open industrial sites, waste storage cells, waste piles, waste monofills and under regulatory tests which attempt to simulate water leaching for determination of hazardousness of any given soil, material or waste.

The present invention also provides a method of reducing the leachability of individual and combined heavy metal bearing material or waste including the groups As, Ag, Ba, Cd, Cr, Pb, Hg, Se, Sb, Cu, Ni, Zn, and combinations thereof under regulatory water extraction test conditions as defined by waste control regulations in UK, Thailand, Japan, Switzerland, Germany, Sweden, The Netherlands and under American Nuclear Standards for sequential leaching of wastes by de-ionized water. The method uses material or waste (pre-leach test and pre-disposal and pre-use) hydration to the maximum degree allowable under regulatory limits criteria (such as the restriction of any free available liquid at landfills as measured under the US paint filter test) and at the maximum specific water retention capabilities of the subject waste or material. This maximum hydration step provides for the sequential optimization of waste or material atmospheric carbonation, and provides an optimal wet-chemistry environment for sequential pH adjustment and waste or material molecular stabilization as needed to meet lead leaching objectives, all at a time-zero, static batch, controlled wet environment condition that is easily managed prior to the extraction testing commonly under tumbled and low pH conditions. The maximum atmospheric carbonation of heavy metals in the waste or material is mostly improved by the now maximum wetted solid metal-atmosphere phase interface. The use of maximum water hydration of waste or material also allows for maximum dilution of waste or material mass used in any given leach test by addition of heavy-metal free or limited heavy metal content water, thus producing a waste extraction sample with less metal surface area and less metal mass potentially leachable under the wet-weight based leaching test. Maximum hydration also produces a maximum surface and pore-space exposure of heavy metals to any added waste or material heavy metal stabilizers introduced to reduce metal leaching potentials such as phosphates, silicates, and sulfides. The wet saturated sample or material environment also allows for metal precipitation and surface ion-exchange reactions to occur at the waste or material and stabilizer derived pH environment without interference of water-based reactions with a leaching test leach environment of acid such as dilute acetic acid under TCLP Fluid 1 and 2. The waste or material wet stabilization environment can thus be optimized by the environmental engineer or chemist at time-zero pre-testing pH conditions, allowing for formation of minerals and compounds under saturated or semi saturated water batch reactor conditions, and even capable of taking advantage of matrix batch reactors environments such as exothermic reaction heat, process induced heat, and, static waste or material water-chemical interface equilibriums.

Unlike the present invention, prior art waste stabilization additive methods have focused on reducing the solubility of heavy metal such as lead, arsenic, cadmium, chromium under leach test conditions, without consideration to optimizing such stabilization reactions and minimizing reactor heavy metal mass exposures by introduction of the maximum allowable weight of water which improves time-zero pre-extraction heavy metal reduction by wetted interface carbonation, mass lead surface and matrix leaching reduction by addition of maximum water weight, maximum time-zero stabilizer conversion of heavy metals at waste or material driven pH ranges versus the extraction test driven pH and leach extract environment such as dilute acetic acid under TCLP, and optimal static and fully hydrated matrix stabilization conditions.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial wastewater contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

### SUMMARY OF THE INVENTION

The present invention discloses a heavy metal bearing material or waste stabilization method by the use of material or waste pre-leach test and pre-disposal and pre-use, hydration of waste or material matrix to the maximum degree allowable under regulatory limits criteria (such as the restriction of any free available water at landfills as measured under the US paint filter test) and maximum specific water retention capabilities of the subject waste or material being stabilized. The maximum hydration method step allows for sequential and subsequent maximum atmospheric carbonation of heavy metals in the waste or material improved by the now maximum wetted solid metal-atmosphere phase interface, and also allows for maximum dilution of waste or material mass used in any given leach test by addition of heavy-metal free or limited heavy metal content water, thus producing a waste extraction sample with less metal surface and less metal mass potentially leachable under the wet-weight based leaching test. The method also produces a maximum surface and pore-space exposure of heavy metals to any added waste or material heavy metal stabilizers added to reduce metal leaching potentials such as phosphates, silicates, and sulfides, and also allows for metal precipitation and exchange reactions to occur at the waste or material and stabilizer derived pH environment without interference of water-based reactions with the leaching test leach environment of acid such as dilute acetic acid under TCLP Fluid 1 and 2. The waste or material stabilization environment can thus be optimized by the environmental engineer or chemist at time-zero pre-testing pH conditions, allowing for formation of minerals and compounds under saturated or semi-saturated water batch reactor conditions, and even capable of taking advantage of matrix batch reactors environments such as exothermic heated water, process heat, and static waste or material interface equilibriums.

The water content maximization metal mass reduction and time-zero carbonation reactions method alone can result in significant reduction of leach test levels such that one can avoid the cost of heavy metal stabilizers and meet non-hazardous or acceptable leaching limits. However, the water content maximization with sequential carbonation and waste or material mass minimization method, is also intended to be used in conjunction with material or waste pH adjusters and stabilizing agents including but not limited to Portland cement, cement kiln dust, lime kiln dust, phosphoric acids and salts, water-soluble phosphoric acids and salts, all phosphoric acid grades and types available in commerce such as agricultural-feed-food grades, monocalcium phosphates, tricalcium phosphates, dicalcium phosphates, dicalcium phosphate dihydrate and dehydrate powder, monodicalcium phosphates, calcium phosphates, single super phosphate, triple superphosphate, ordinary superphosphates, phosphate fertilizers, phosphate rock, phosphates, phosphate salts, dolomitic lime, limestone, lime, quicklime, silicates, sulfides, sulfates, carbonates, chlorides, bone phosphates, iron filings, iron powder, ferric chloride, ferrous sulfate, ferric sulfate and combinations thereof which are properly chosen to complement the material or waste leaching potential reductions.

### DETAILED DESCRIPTION

Environmental regulations throughout the world such as those promulgated by the USEPA under RCRA and CERCLA require heavy metal bearing waste and material producers to manage such materials and wastes in a manner safe to the environment and protective of human health. In response to these regulations, environmental engineers and scientists have developed numerous means to control heavy metals, mostly through chemical applications which convert the solubility of the material and waste character to a low soluble form, thus passing leach tests and allowing the wastes to be either reused on-site or disposed at local landfills without further and more expensive control means such as hazardous waste disposal landfills or facilities designed to provide metals stabilization. The primary focus of scientists has been mostly on singular heavy metals such as lead, cadmium, chromium, arsenic and mercury, as these were and continue to be the most significant mass of metals contamination in soils. Materials such as lead paints, incinerator ash, foundry and mill flyash, auto shredder and wire shredding residues and cleanup site wastes such as battery acids and slag wastes from smelters are major lead sources. Recently, however, there exists a demand for control methods of various heavy metals such as As, Ag, Ba, Cd, Cr, Pb, Cu, Sb, Se, Ni, and Zn and combinations thereof in mining waste, wastewater sludge, incinerator ashes, foundry dusts, steel mill dusts, and contaminated soils to meet TCLP and also SPLP, MEP, DI and other measures intended to measure field condition leaching and/or solubility of the metals under digestion, in a manner which is low cost.

The present invention provides a method of reducing the leaching potential of individual and/or combined heavy metal bearing material or waste including the groups As, Ag, Ba, Cd, Cr, Pb, Hg, Se, Sb, Cu, Ni, Zn, and combinations thereof under TCLP, SPLP, MEP, CALWET, DI, rainwater and surface water leaching conditions as well as under regulatory water extraction test conditions as defined by waste control regulations in UK, Thailand, Japan, Switzerland, Germany, Sweden, The Netherlands and under American Nuclear Standards for sequential leaching of wastes by de-ionized water. The method uses material or waste (pre-leach test and pre-disposal and pre-use) hydration of waste or material matrix to the maximum degree allowable under regulatory limits criteria (such as the restriction of any free available water at landfills as measured under the US paint filter test) and maximum specific water retention capabilities of the subject waste or material being stabilized. The maximum hydration method allows for sequential maximum atmospheric carbonation of heavy metals in the waste or material improved by the now maximum wetted solid metal-atmosphere phase interface and also allows for maximum dilution of waste or material mass used in any given leach test by addition of heavy-metal free or limited heavy metal content water, thus producing a waste extraction sample with less metal surface and less metal mass potentially leachable under the wet-weight based leaching test. The method also produces a maximum surface and pore-space exposure of heavy metals to any added waste or material heavy metal stabilizers added to reduce metal leaching potentials such as phosphates, silicates, and sulfides, and also allows for metal precipitation and exchange reactions to occur at the waste or material and stabilizer derived pH environment without interference of water-based reactions with the leaching test leach environment of acid such as dilute acetic acid under TCLP Fluid 1 and 2. The waste or material stabilization environment can thus be optimized by the environmental engineer or chemist at time-zero pre-testing pH conditions, allowing for formation of minerals and compounds under saturated or semi-saturated water batch reactor conditions, and even capable of taking advantage of matrix batch reactors environments such as exothermic heated water, process heat, and static waste or material interface equilibriums.

Unlike the present invention, prior art waste stabilization additive methods have focused on reducing the solubility of heavy metal such as lead, arsenic, cadmium, chromium under leach test conditions, without consideration to optimizing such stabilization with introduction of the maximum allowable weight of water thus improving time-zero pre-extraction heavy metal reduction by wetted interface carbonation, heavy metal surface and mass reduction, maximum time-zero stabilizer conversion of heavy metals at waste or material driven pH ranges versus the extraction test driven pH and leach extract environment such as dilute acetic acid under TCLP.

The water content maximization metal mass reduction and time-zero carbonation reactions method can result in significant reduction of leach test levels such that one can avoid the cost of heavy metal stabilizers and meet non-hazardous or acceptable leaching limits. However, the water content maximization method is also intended to be used in conjunction with material or waste pH adjusting and stabilizing agents including but not limited to Portland cement, cement kiln dust, lime kiln dust, phosphoric acids and salts, water-soluble phosphoric acids and salts, all phosphoric acid grades and types available in commerce such as agricultural-feed-food grades, monocalcium phosphates, tricalcium phosphates, dicalcium phosphates, dicalcium phosphate dihydrate and dehydrate powder, monodicalcium phosphates, calcium phosphates, single super phosphate, triple superphosphate, ordinary superphosphates, phosphate fertilizers, phosphate rock, phosphates, phosphate salts, dolomitic lime, limestone, lime, quicklime, silicates, sulfides, sulfates, carbonates, chlorides, bone phosphates, iron filings, iron powder, ferric chloride, ferrous sulfate, ferric sulfate and combinations thereof which are properly chosen to complement the material or waste leaching potential.

Although the exact waste or material water content, heavy metal surface area and mass reduction, time-zero reaction duration, optimal pH conditions, and optimized carbonation and stabilization matrix, are not entirely known at this time, it is expected that when the surface area and mass of heavy metals is minimized, and waste or material wetted surfaces come into contract with atmospheric CO2, and a time-zero pH condition exists at stable level and equilibrium, and stabilizing agent(s) are in the presence of maximum water and material water content, that lower solubility heavy metal minerals and molecules form at the highest rate possible, being less soluble than the heavy metal element or molecule originally in the material or waste and at significant less mass potential leaching than a dry waste or material sample. It also remains possible that modifications to waste and material zero-time matrix environment temperature and pressure prior to sample analyses may accelerate of assist in mass reduction, wetted interface production, and formation of minerals prior to the sample extraction test acid pH environment. However, such waste and material environmental conditions are not considered optimal for this application given the need to limit cost and provide for optional field based stabilizing operations that would be complicated by the need for pressure and temperature control devices and vessels. A fully-wetted waste or material can of course take maximum advantage of possible chemical reactions at time-zero pre-extraction such as lime exothermic heating, lime pH environment adjustment and subsequent precipitations and flocculation formations under static and equilibrium wet-chemistry conditions.

The amounts of water hydration used alone or in combination with carbonation, mass reduction, aging, waste or material pH adjustment, and waste or material wet saturate environment stabilization, according to the method of invention, depend on various factors including waste or material specific retention, mass reduction potential and need, limitations of regulations such as zero free-water drainage from landfill waste or material, desired solubility reduction by carbonation and carbonation potential, stabilization chemicals desired or required in combination with the water, desired waste or material mineral toxicity, and desired mineral formation relating to toxicological and site environmental control objectives. It has been found that an amount of 15% to 40% water by weight of waste or material is sufficient for initial TCLP leaching to less than RCRA limits, such as 5.0 ppm for Pb. However, the foregoing is not intended to preclude yet higher or lower usage of water optimization level or combinations with pH adjusters and/or stabilizers if needed, since it has been demonstrated that amounts greater and smaller than 15% to 40% maximum hydration water and combinations with stabilizers from 0.5% to 1.0% by wet weight of waste or material also provide for desired heavy metal leaching level and potential reduction. The examples below are merely illustrative of this invention and are not intended to limit it thereby in any way.

### Example 1

In this example lead bearing Refuse Derived Fuel (RDF) incinerator Flyash Scrubber Residue (FASR) was tested bone-dry and also hydrated with 45% tap water Moisture Content (mc) by weight of dry FASR, and with lead stabilizers Granular Triple Superphosphate (GTSP) and MonoDiCalcium Phosphate (MDCP). Samples were aged by three days of sample curing in a sealed and cooled glass container, and three days of sample curing in an open glass container under testing lab airspace at STP. All FASR samples were subsequently tested for TCLP Pb. Samples were extracted according to TCLP procedure set forth in Federal Register, Vol. 55, No. 126, pp. 26985-26998 (Jun. 29, 1990), incorporated by reference.

TABLE 1

| FASR Hydration/Aging | TCLP Pb (ppm) |
|---|---|
| Bone Dry-Sealed | 9.32 |
| Bone Dry-Open Air | 9.11 |
| Wetted-Sealed to 45% mc | 5.49 |
| Wetted-Open Air | 3.27 |
| Wet open + 1% GTSP | 0.15 |
| Wet open + 1% MDCP | 0.27 |

### Example 2

In this example lead bearing Copper Wire Insulation (CWI) was tested bone-dry and also hydrated with 11% tap water by dry weight of CWI, and with lead stabilizers Granular Triple Superphosphate (GTSP) and MonoDiCalcium Phosphate (MDCP). Samples were aged by three days of sample curing in a sealed and cooled glass container, and three days of sample curing in an open glass container under testing lab airspace at STP. All samples were subsequently tested for TCLP Pb. Samples were extracted according to TCLP procedure set forth in Federal Register, Vol. 55, No. 126, pp. 26985-26998 (Jun. 29, 1990), incorporated by reference.

TABLE 2

| CWI Hydration/Aging | TCLP Pb (ppm) |
|---|---|
| Bone Dry-Sealed | 12.50 |
| Bone Dry-Open Air | 12.52 |
| Wetted-Sealed to 11% mc | 7.33 |
| Wetted-Open Air | 5.7 |
| Wet open + 1% GTSP | 0.07 |
| Wet open + 1% MDCP | 0.16 |

### Example 3

In this example lead bearing Automobile Shredder Residue (ASR) was tested bone-dry and also hydrated with 12% tap water by dry weight of ASR, and with lead stabilizers Granular Triple Superphosphate (GTSP) and MonoDiCalcium Phosphate (MDCP). Samples were aged by three days of sample curing in a sealed and cooled glass container, and three days of sample curing in an open glass container under testing lab airspace at STP. All samples were subsequently tested for TCLP Pb. Samples were extracted according to TCLP procedure set forth in Federal Register, Vol. 55, No. 126, pp. 26985-26998 (Jun. 29, 1990), incorporated by reference.

TABLE 3

| ASR Hydration/Aging | TCLP Pb (ppm) |
|---|---|
| Bone Dry-Sealed | 7.29 |
| Bone Dry-Open Air | 7.22 |
| Wetted-Sealed to 12% mc | 4.87 |
| Wetted-Open Air | 4.11 |
| Wet open + 0.5% GTSP | <0.05 |
| Wet open + 0.5% MDCP | <0.05 |

### Example 4

In this example lead contaminated soil (PBS) was tested bone-dry and also hydrated with 34% tap water by dry weight of soil, and with lead stabilizers Granular Triple Superphosphate (GTSP), MonoDiCalcium Phosphate (MDCP), and wet process phosphoric acid (H3PO4). Samples were aged by three days of sample curing in a sealed and cooled glass container, and three days of sample curing in an open glass container under testing lab airspace at STP. All samples were subsequently tested for TCLP Pb. Samples were extracted according to TCLP procedure set forth in Federal Register, Vol. 55, No. 126, pp. 26985-26998 (Jun. 29, 1990), incorporated by reference.

TABLE 4

| PBS Hydration/Aging | TCLP Pb (ppm) |
|---|---|
| Bone Dry-Sealed | 14.73 |
| Bone Dry-Open Air | 14.29 |
| Wetted-Sealed to 34% mc | 9.49 |
| Wetted-Open Air | 8.11 |
| Wet open + 0.5% GTSP | 3.05 |
| Wet open + 0.5% MDCP | 4.35 |
| Wet open + 0.5% H3PO4 | 3.712 |

### Example 5

In this example lead paint residue (PPR) was tested bone-dry and also hydrated with 38% tap water by dry weight of soil, and with lead stabilizers Granular Triple Superphosphate (GTSP), MonoDiCalcium Phosphate (MDCP), and wet process phosphoric acid (H3PO4). Samples were aged by three days of sample curing in a sealed and cooled glass container, and three days of sample curing in an open glass container under testing lab airspace at STP. All samples were subsequently tested for TCLP Pb. Samples were extracted according to TCLP procedure set forth in Federal Register, Vol. 55, No. 126, pp. 26985-26998 (Jun. 29, 1990), incorporated by reference.

TABLE 5

| PPR Hydration/Aging | TCLP Pb (ppm) |
|---|---|
| Bone Dry-Sealed | 12.66 |
| Bone Dry-Open Air | 12.21 |
| Wetted-Sealed to 38% mc | 10.93 |
| Wetted-Open Air | 9.43 |
| Wet open + 0.5% GTSP | 4.75 |
| Wet open + 0.5% MDCP | 4.82 |
| Wet open + 0.5% H3PO4 | 4.71 |

The foregoing results in Table 1 thru 5, readily established the operability of the present process to reduce leach test solubility. Given the effectiveness of the method in reducing heavy metal leaching as presented in the Table 1 thru 5, it is believed that an amount of the wetting equivalent to 10% to 50% by weight of heavy metal bearing material or waste should be effective. It is also apparent from the Table 1 thru 5, that certain wetting content and aging and carbonation duration are more effective for stabilization depending on waste or material composition.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the solubility of heavy metals from waste or material, comprising contacting said waste or material with (1) at least one hydration source added at a dosage level that maximizes water addition content within regulatory allowable limits and surface wetting that allows for waste and material mass weight reduction and maximum wetted surface interface, and if needed to further reduce heavy metal solubility (2) in combination with atmospheric carbonation and aging duration that allows for formation of heavy metal carbonate, and if needed to further reduce heavy metal solubility (3) in combination with a pre-extraction test pH adjuster that allows for formation of heavy metal minerals at the pH environment provided prior to exposure to extraction fluid acids, and if needed to further reduce heavy metal solubility (4) in combination with heavy metal stabilizers, all in amounts effective in reducing the leaching of heavy metal from waste or material to a level desired.

2. The method of claim 1, wherein the hydration source is water, process water, potable water, rainwater, ground water, stream or river water, wastewater, process wastewater, filtered or unfiltered process wastewater, wastewater.

3. The method of claim 1, wherein the duration of atmospheric carbonation and aging ranges from one second to 60 seconds, from sixty seconds to sixty minutes, from one hour to 24 hours, from 24 hours to 30 days, from 30 days to 365 days, and between one second and 365 days.

4. The method of claim 1, wherein the pH adjusting agent is selected from the group consisting of sulfuric acid, phosphoric acid, nitric acid, hydrochloric acid, waste process acid, aluminum anodizing acid waste coproduct solution, lime, dolomitic lime, limestone, magnesium oxide, sodium hydroxide, Portland Cement, sodium silicate, and combinations thereof.

5. The method of claim 1, wherein the stabilizing agent is selected from the group consisting of phosphates, sulfates, sulfides, Portland cement, silicates, cement kiln dust, lime, dolomitic lime, magnesium oxide, limestone, sodium hydroxide, ferric chloride and mineral complexing agent combinations, wet process amber phosphoric acid, wet process green phosphoric acid, coproduct phosphoric acid solution from aluminum anodizing and polishing, technical grade phosphoric acid, hexametaphosphate, polyphosphate, calcium orthophosphate, superphosphates, triple superphosphates, phosphate fertilizers, single superphosphate, ordinary phosphate, crop production run phosphate, phosphate rock, bone phosphate, fishbone phosphates, tetrapotassium polyphosphate, monocalcium phosphate, monoammonia phosphate, diammonium phosphate, dicalcium phosphate, dicalcium phosphate dihydrate and dihydrate powders, tricalcium phosphate, trisodium phosphate, salts of phosphoric acid, and combinations thereof.

6. The method of claim 1, wherein the waste or material is heavy metal bearing hazardous or non-hazardous waste or materials including (1) Fly Ash, Scrubber Residue, Bottom Ash, Slag, Fireside Boiler Wash-down Solids, Floor Drain Solids, Filter Press Solids, Combined Ash, and combinations thereof, produced from refuse derived fuel incineration, mass burn trash incineration, fossil fuel combustion, smelting operations, steel furnace operations, foundry operations, biomass combustion, casting operations, and industrial and commercial facility air pollution control devices; and (2) Copper wire insulation and wire insulation wastes and materials from production of wire and recovery and recycling of copper wire; and (3) Automobile shredder residue and wastes and materials produced from the recycling and recovery of ferrous and non-ferrous metals from spent automobiles; and (4) industrial and commercial facility generated wastes, hazardous wastes, non-hazardous wastes, residues, sludge, spent wastes, byproduct wastes and materials, sediments, wastewater sludge and settling wastes and materials; and (5) heavy metal contaminated soils and environmental generated materials contaminated with industrial, commercial and/or residential lead bearing wastes and materials and (6) heavy metal paint blast wastes and residues with and without blast media.

7. The method of claim 1 wherein reduction of solubility is to a level no more than non-hazardous levels as determined under no more than non-hazardous levels as determined in an USEPA TCLP test, performed on the stabilized material or waste, as set forth in the Federal Register, vol. 55, no. 126, pp. 26985-26998 (Jun. 29, 1990), and under leach tests required by regulation in countries other than the USA including but not limited to Canada, Mexico (SPLP), South America, Japan (DI), Taiwan (TCLP), China (TCLP×3), Philippines (TCLP), Switzerland (DI Combination), Germany, Denmark, Norway, France, Sweden, United Kingdom, Italy, and Greece.

8. The method of claim 1 wherein the heavy metal is from the elemental, molecular or mineral groups of As, Ag, Ba, Cd, Cr, Hg, Pb, Se, Cu, Zn, Sb.
